(19) United States
(12) Patent Application Publication
(10) Pub. No.: US 2017/0004553 A1
(43) Pub. Date: Jan. 5, 2017

(54) METHOD FOR PRESENTING INDIVIDUAL ADVERTISING AND PRICE INFORMATION IN A SHOP

(71) Applicants: Mikhail Borisovich BUDILOV, St.Petersburg (RU); Dmitry Anatolievich ZASHCHERINSKIY, St.Petersburg (RU); Alexander Borisovich TSYGANOV, St.Petersburg (RU)

(72) Inventors: Mikhail Borisovich BUDILOV, St.Petersburg (RU); Dmitry Anatolievich ZASHCHERINSKIY, St.Petersburg (RU); Alexander Borisovich TSYGANOV, St.Petersburg (RU)

(21) Appl. No.: 15/039,792

(22) PCT Filed: Dec. 1, 2014
(86) PCT No.: PCT/RU2014/000900

§ 371 Date: May 26, 2016

(30) Foreign Application Priority Data
Nov. 29, 2013 (RU) 2013152893

(51) Int. Cl. G06Q 30/06; G06K 7/14; G06Q 30/02

(52) U.S. Cl. CPC G06Q 30/0623; G06Q 30/0226; G06Q 30/0267; G06K 7/1417

(57) ABSTRACT

Method of providing automated individual promotional and price information to a customer at the moment of viewing goods of interest in self-service stores. It comprises software application with identification code pre-installed on the customer's smart phone, automatic reading of machine-readable code (for example, QR code) applied on the name and price labels or stickers of commodities located at the store shelves using, e.g., smart phone photo camera. Code information is transmitted via mobile Internet to Data Processing Center and media file is sent back to a customer smart phone with personalized, in dependence on his purchasing history, content and personal discount on selected goods. Method further comprises transmission of selected commodity code and amount of discount granted from Data Processing Center to a store computer controlling check-outs. As a result, calculation of total receipt with all granted discounts at the check-out is automatically performed, when the customer presents to a cashier his identification code on the smart phone screen.

### FIELD OF THE INVENTION

The present invention relates to retail trade and is intended for automated providing personalized promotional information and price discounts to customers in retail stores taking into account their previous consumer behavior and purchase amounts.

### PRIOR ART

Methods and devices for encoding and automatic reading of information from printed trade-related labels which provide application of a sufficiently large volume of identification information (more than 3 Kbytes) and automatic reading of this information with various scanners, including mobile devices, for example, a method of QR code machine reading according to U.S. Pat. No. 8,515,162 are known. Common features with claimed invention are that this method ensures application of machine-readable codes; however, specified method does not allow automatic identification of a buyer who examines the label.

Methods and devices for encoding and reading of QR codes (U.S. Pat. No. 8,494,958 and U.S. Pat. No. 8,296,477) for communication via Internet are known. Common features with claimed invention are that specified analogues provide QR code inserted into a message which is addressed to user, and user's personalized information is included into QR code for convenience of its further processing without repeated manual input. However, this method does not allow carrying out automated identification of a buyer in a purchase point, giving customer a personalized promotional and discount information, as well as automatic data accumulating on consumer preferences of this buyer.

Devices for encoding of goods at retail trade space areas are known (see, for example, use of QR codes as per U.S. Pat. No. 8,272,562 and U.S. Pat. No. 8,261,972). Common features with claimed invention are that QR code is applied on each goods type which is covered by promotional information, and a product identification number is entered into QR code for future use of it by a purchaser. However, this method does not allow carrying out automated identification of a buyer in a purchase point, giving customer a personalized promotional and discount information, as well as automatic data accumulating on consumer preferences of this buyer.

A method of data exchange between user's mobile device and a server which is initiated with QR codes is known (US patent application No. 20130018726). Common features with the claimed invention are that machine-readable QR code is applied on a visual informational pointer (label) and a website URL is included into the code, whereby the user's mobile device browses this website of ter automatic reading of this QR code. However, specified method doesn't allow carrying out automated identification of a buyer in a purchase point, giving this customer an individual promotional and discount information. Also, specified method doesn't allow proper payment accounting for individually discounted goods, as well as automatic data accumulating on consumer preferences of this buyer.

Method of data exchange between user's mobile device and a server which is initiated with QR codes is known (US patent application No. 20130179156). Common features with the claimed invention are that a machine-readable code is applied in the area of informational label which determines the name and the price of an article located at this trade place. Also, a code reading with the user's mobile device and its transmission to a data processing center and reverse information transmission to the user is provided. However, specified method does not allow carrying out automated identification of a buyer in a purchase point, giving this customer an individual promotional and discount information, proper accounting when paying for individually discounted goods, as well as automatic data accumulating about consumer preferences of this buyer.

The closest technical solution to the claimed invention is US patent application No. 20130233916, which is selected as a prototype. As per the prototype, a method of applying a machine-readable code on a visual information pointer; entering of an object identification number (with which a pointer is linked) into the machine-readable code; code reading by user's mobile device; its transmission to data processing center and reverse transmission of information to the user is proposed. Common features of the prototype with the claimed invention are that machine-readable code is applied in the area of informational pointer (label or sticker), which determines the name and price of goods located at the trade place; identification number of this goods article and the store identification number are entered into a machine-readable code; code reading and its transmission to a data processing center with customer mobile device are provided. However, as per the prototype, there is no possibility to carry out automated customer identification at the purchase point (area of product selection), because of a pre-registration of a customer in the data processing center and a possibility of his authorization at the point of purchase are lacking in the prototype. Due to lack of authorization, the prototype has no opportunity to give a customer the personalized promotion and, what is of most importance, financially relevant individual information on a discount. Proper discount accounting when paying at a store check-out counter for eventually selected goods only are also lack ing in the prototype (according to claimed invention a customer has the opportunity to select commodity and receive a personal discount, and then change his mind and return goods on a shelf). Besides, there is no possibility in the prototype to ensure transmission of information already from the store check-out counter to the data processing center on finally paid goods for automated data storage on consumer preferences and for determination of subsequent discounts and personalized commercials.

### DISCLOSURE OF INVENTION

Technical result by proposed invention provides improvement of the accuracy of each individual customer consumer preferences accounting and automation of a store marketing policy in relation to each individual customer.

The present invention aims to establish such a method of communication between store and customer which allows store automated providing the personalized promotion information and personal discounts to each customer depending, for example, on consumer preferences and previous purchase amounts. To solve this task, a prior art US application No. 20130233916 (the prototype), which comprises a machine-readable code applying in an information pointer area which determines the name and price of goods located at this trade place; entering in a machine-readable code the identification number of the commodity and store identification number; providing reading and transmission of the data with customer mobile device from a machine-readable code to data processing center, is modified. In comparison to a prototype, a software application is pre-installed in a customer mobile device which is equipped with a video camera. This software application starts and registers customer individual code to a data processing center. And then software application allows determination of selected machine-readable code after pointing camera on it; wireless transmission to the data processing center of a message with a store code, commodity code in the customer pointed area and an individual customer code; getting on mobile device screen a response personalized promotional information and a price discount for the customer, as well as registration and transmission to data processing center of a fact of custom er's consent to purchase this commodity; ensure accounting of granted individual discounts at a store check-out counter when paying for the presented goods; transmission to a data processing center an information on goods actually paid by the customer.

Thus, a proposed method provides customer an opportunity to point the camera to commodity that is of interest to him with the help of smartphone with video camera and pre-installed software application which is registered at a data processing center, automatically extracts information from machine-readable label, and transmits it to that data processing center. Then the software of a store or goods manufacturer analyses customer's prior consumer history according to the database and transmits a personalized promotional information (video commercial, image, voice message or the like) and amount of a personal discount for this commodity to above application on custom er's smartphone. Then, customer makes a purchase decision and smartphone transmits this information to data processing center in the case of a positive decision. Thereafter, the data processing center transmits information on custom er's code, number of selected commodity, and amount of granted discount to computer which controls check-out counters at a store exit. Customer can act similarly, as described above, when selecting other goods in this store. After the customer puts all his goods in a basket, presents them for payment at a store check-out counter, together with presenting of his registration code (for example, in the form of a barcode on smartphone screen), software of the computer which controls a check-out counter wills can customer's personal discounts obtained from the data processing center and calculate a bill with account of them.

In a particular implementation of proposed invention, radio-frequency identification (RFID) mark is used as a machine-readable identification code, and a mobile device is provided with radio-identification marks reading device.

In another particular embodiment of proposed invention, QR code is used as a machine-readable code.

Also, in particular implementation of proposed invention, individual price information is provided in the form of discounts to a set price of goods.

In another particular case of proposed invention embodiment, personal price information is provided in the form of bonus points which allow acquiring of the next commodity piece for free after a few purchases.

### BRIEF DESCRIPTION OF THE DRAWINGS

FIG. 1 shows a diagram of data transfer between custom er's smartphone, data processing center, and computer that controls store checkouts.

### DETAILED DESCRIPTION OF THE PREFERRED EMBODIMENTS

Proposed invention embodiment is illustrated by the following specific particular embodiment examples, what in no way should be considered as narrowing or reduction in a scope of a claimed invention.

It is known that self-service stores are interested in implementation of automated individual marketing approach to each customer, so as to deliver customer personalized promotional information based on automated processing of previous history of consumer preferences of this customer, as well as to provide personal price discounts depending on previous amount of purchases and, thus, stimulate sales. Moreover, the majority of population carries around various mobile wireless devices equipped with wireless Internet access and video cameras.

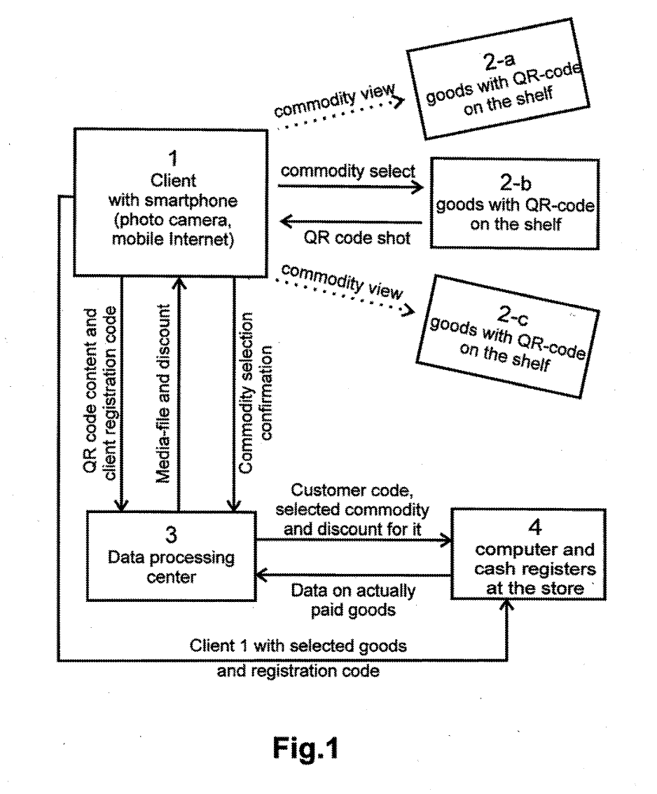

On this platform in a present invention an automated communication system between a customer and a store directly at the purchase point, i.e. in sales area, is shown in the form of block diagram in FIG. 1. At that, self-service retail logistics which is the most widespread in the world is subjected to minor changes.

According to claimed invention, store Customer 1 goes in the sales area wherein a variety of 2-a, 2-b, 2-c goods for sale shown schematically in FIG. 1 are laid out on shelves and other commercial equipment (hangers, racks, etc.). At that, at the trade place of each commodity type (e.g., shelf area) several pieces of this commodity, as a rule, are laid out, as well as a printable label with commodity name and price is placed. As per the invention, a machine-readable code (e.g., known QR code) is applied additionally on the label, where in the identification number of the commodity and the store identification number are indicated. Customer 1 has a mobile device (smartphone) with photo camera in his hands wherein the special software application is pre-installed that provides communication to Data Processing Center 3 via wireless Internet (for example, Wi-Fi or mobile operator network) whereof the Customer 1 once pre-loaded specified software application and received a unique registration code. Customer 1 individual registration code and data on his subsequent purchases are stored in a database on server of Data Processing Center 3 or in another types of distributed data storage systems, for example, in cloud Internet services. To obtain this registration code, Customer 1 can communicate his personal data or register anonymously. Identification number databases of all the goods in a store and in data processing center are also synchronized in advance (i.e. codes of the same commodity in computer accounting system of a store and in database of Data Processing Center 3 will always coincide). These databases can also be stored in distributed storage systems.

When Customer 1 enters a sales area, he activates the specified software application in his smartphone and looks at spread out goods (2-a, 2-b, 2-c and commodity view dotted arrows in FIG. 1). Then he points his smartphone camera at a label with machine-readable product code (for example, 2-b) which attracted his attention, and presses the activation button (commodity selection arrow in FIG. 1). An application installed on the smartphone provides automatic reading of a label image (QR code shot arrow in FIG. 1) by photo camera, recognition of the contents of a machine-readable QR code, and transmission with mobile device of a Customer 1 registration code, store code and code of the selected commodity to Data Processing Center 3 (contents of QR code and customer code arrow in FIG. 1). Data Processing Center 3 finds needed records in the database according to Customer 1 registration code and sends a media file in response via wireless Internet to smartphone of Customer 1 (media file and discount arrow in FIG. 1). This file can contain various multimedia information (advertising photo, video, audio message, as well as information on personal discount for Customer 1 on selected commodity) according to prior automatically accumulated history of this customer purchases and marketing algorithms of a store, trade network, or owner of the goods. Getting a response from Data Processing Center 3 can be accompanied, for example, with smartphone audio signal.

If customer is satisfied with received multimedia information and discount, he presses selection confirmation button (commodity selection confirmation arrow in FIG. 1), and Data Processing Center 3 transmits through communication channel (e.g., wired or wireless Internet) the data on registration code of Customer 1 and selected by Customer 1 commodity code (in this case—2-b) into checkouts controlling computer 4 at the s tore which is encoded in QR code of the selected commodity. Specified discount should be granted when paying (customer code, selected commodity and discount for it shown by the arrow in FIG. 1). Customer 1 selects needed amount of the chosen 2-b commodity in a basket or handcart and continues the process of further purchases in the same way.

After goods selection completion, Customer 1 comes with a basket to one of the store Cash Register 4 and shows his registration code to a cashier (for example, above mentioned software application can display a barcode with Customer 1 registration code on a smartphone screen, similar to discount cards in retail network stores). After entering a registration code in checkout Cash Register 4, the ordinary procedure of all selected goods identification by the cashier (for example, with the help of barcode reader) and counting of the amount for payment begins. At the same time, Cash Register 4 software takes into account the information which was transmitted from Data Processing Center 3 on discounts for certain types of goods and displays it in a total receipt. Customer 1 pays a receipt in any regular way, and purchasing process is completed now. After that, Cash Register 4 via store computer transmits to Data Processing Center 3 the information on actually paid by Customer 1 goods for accumulation of information on purchases and consumer preferences of the customer (data on actually paid goods arrow in FIG. 1). At that, Customer 1 can abandon some of previously selected goods in purchase process and bring them back on shelf, but in this case process logistics are not be disturbed: if commodity is not presented at the Cash Register 4, then the discount will not be accrued.

Also, radio-identification mark can be used as a machine-readable code in a label on commodity shelf, and smartphone can be equipped with radio-identification marks reading de vice. At that, in order to obtain personalized information and discounts on selected goods, customer just runs his smartphone with reader close to a label, and further system operation logic is similar to that described above.

Data Processing Center 3 can be established by one or several stores, as well as retail networks, or be a stand-alone enterprise and provide such services to specified organizations on a reimbursable basis. To manage trading process, store managers have the opportunity to change response algorithms, the content of media files and discount amounts that are used by data processing center for automatic responses to requests of mobile customers who send the identification code of this store quickly through remote access channel. Store or network administrators also have the opportunity to download information on all registered custom er's purchases in their stores from data processing center to their computers. Moreover, according to a trade policy of a particular s tore or retail network, or goods manufacturer, the individual price information can be provided in the form of discounts to set price of commodity or in the form of bonus points which allow acquiring next piece of commodity for free after a few purchases.

Proposed automated system of communications between customer and store allows servicing of one or simultaneously multiple stores or retail networks, at that the customer is logged on data processing center server and downloads software application to his smartphone once for service in all participant stores of automated marketing system. Stores of different owners differ in system by their identification numbers recorded in QR codes. The system is protected against abuse by means of providing actual discount only after identification in data processing center and only on those real goods which are presented at a checkout. If registered smartphone will be used by several persons simultaneously, software program of discount accounting running in data processing center will limit granting of number and amount of discounts if certain thresholds are exceeded during specified time period.

### INDUSTRIAL APPLICABILITY

For a claimed invention embodiment, the following wide-spread equipment is used: tablet computers and smartphones with mobile Internet connection, as well as computer servers and computerized in-store equipment. Claimed invention can be used in retail trade for a wide range of goods.

1. Method for presenting individual advertising and price information in a shop comprising:
applying a machine-readable code in information pointer area, which determines the name and price of commodity located at a definite trade place in a shop;
entering the identification number of said commodity and said shop identification number in a machine-readable code;
providing reading with custom er's mobile device of said machine-readable code and transmitting content to a data processing center;
pre-installing a software application in a customer's mobile device, which registers an individual customer code in said data processing center;
providing in a shop of an opportunity to point said customer's mobile device at said machine-readable code of the commodity that is of interest for the consumer;
determining with the help of said software application of machine-readable code content;
transmitting shop code, commodity code and individual customer code by said customer's mobile device to said data processing center;
receiving in response of personalized promotional and price information on said mobile device screen;
registering and transmitting customer's consent to purchase this commodity to data processing center;
accounting of granted individual discounts at the shop check-out counter when consumer pays for the presented goods;
transmitting of information on the goods actually paid by the customer to said data processing center.

2. A method according to claim 1 wherein said machine-readable code is a QR code and said customer's mobile device is equipped with photo camera.

3. A method accord ing to claim 1 wherein radio-identification mark is used as a machine-readable code and said mobile device is equipped with radio-identification reading means.

4. A method according to claim 1 wherein individual price information is provided in the form of discounts to set goods price.

5. A method according to claim 1 wherein individual price information is provided in the form of bonus points which allow acquiring of the next commodity piece for free after a few purchases.
